(19) United States
(12) Patent Application Publication
(10) Pub. No.: US 2005/0060608 A1
(43) Pub. Date: Mar. 17, 2005

(54) Maximizing processor utilization and minimizing network bandwidth requirements in throughput compute clusters

(76) Inventor: Benoit Marchand, Montreal (CA)

Correspondence Address: CARR & FERRELL LLP, 2200 GENG ROAD, PALO ALTO, CA, 94303, US

(21) Appl. No.: 10/893,752

(22) Filed: Jul. 16, 2004

Related U.S. Application Data
(63) Continuation-in-part of application No. 10/445,145, filed on May 23, 2003.
(60) Provisional application No. 60/488,129, filed on Jul. 16, 2003.

(30) Foreign Application Priority Data
May 23, 2002 (EP) 02011310.6

(51) Int. Cl. G06F 11/00

(52) U.S. Cl. 714/18

(57) ABSTRACT

Exemplary methods and apparatus for improving speed, scalability, robustness and dynamism of data transfers and workload distribution to remote computers are provided. Computing applications, such as Genomics, Proteomics, Seismic, Risk Management require a priori or on-demand transfer of sets of files or other data to remote computers prior to processing taking place. The fully distributed data transfer and data replication protocol of the present invention permits transfers which minimize processing requirements on master transfer nodes by spreading work across the network and automatically synchronizing the enabling and disabling of job dispatch functions with workload distribution mechanisms to enable/disable job dispatch activities resulting in higher scalability than current methods, more dynamism and allowing fault-tolerance by distribution of functionality. Data transfers occur asynchronously to job distribution allowing full utilization of remote system resources to receive data for job queues while processing jobs for previously transferred data. Processor utilization is further increased as file accesses are local to systems and bear no additional network latencies that reduce processing efficiency.

### CROSS-REFERENCE TO RELATED APPLICATIONS

This application claims the priority benefit of U.S. Provisional Patent Application No. 60/488,129 filed Jul. 16, 2003 and entitled “Throughput Compute Cluster and Method to Maximize Processor Utilization and Maximize Bandwidth Requirements”; this application is also a continuation-in-part of U.S. patent application Ser. No. 10/445,145 filed May 23, 2003 “Implementing a Scalable Dynamic, Fault-Tolerant, Multicast Based File Transfer and Asynchronous File Replication Protocol”; U.S. patent application Ser. No. 10/445,145 claims the foreign priority benefit of European Patent Application Number 02011310.6 filed May 23, 2002 and now abandoned. The disclosures of all the aforementioned and commonly owned applications are incorporated herein by reference.

### BACKGROUND

1. Field of the Invention

The present invention relates to transferring and replicating data among geographically separated computing devices and synchronizing data transfers with workload distribution management job processing. The invention also relates to asynchronously maintaining replicated data files, synchronizing job processing notwithstanding computer failures and introducing new computers into a network without user intervention.

2. Description of the Related Art

Grid computers, computer farms and similar computer clusters are currently used to deploy applications by splitting jobs among a set of physically independent computers. Disadvantageously, job processing using on-demand file transfer systems reduces processing efficiency and eventually limits scalability. Alternatively, data files can first be replicated to remote nodes prior to a computation taking place, but synchronization with workload distribution systems must then be handled manually; that is, a task administrator reboots a failed node or introduces a new node to the system.

The existing art as it pertains to address data file transfer and workload distribution synchronization generally falls into four categories: on-demand file transfer, manual file transfer through a point-to-point protocol, manual transfer through a multicast protocol and specialized point-to-point schemes.

Tasks can make use of on-demand file transfer apparatus, better known as file servers, Network Attached Storage (NAS) and Storage Area Network (SAN). For problems where file access is minimal, this type of solution works as long as a cluster size (i.e., number of remote computers) is limited to a few hundred due to issues related to support of connections, network capacity, high I/O demand and transfer rate. For large and frequent file accesses, this solution does not scale beyond a handful of nodes. Moreover, if entire data files are accessed by all nodes, the total amount of data transfer will be N times that of a single file transfer (where N is the number of nodes). This results in a waste of network bandwidth thereby limiting scalability and penalizing computational performance as nodes are blocked while waiting for remote data (e.g., while a remote data providing source fulfills local data requests). Synchronization of data transfer and workload management is, however, implicit and requires no manual intervention.

Users or tasks can manually transfer files prior to task execution though a point-to-point file transfer protocol. Point-to-point methods, however, impose severe loads on the network thereby limiting scalability. When data transfers are complete, synchronization with local workload management facilities must be explicitly performed (e.g., login and enable). Moreover, additional file transfers must continually be initiated to cope with the constantly varying nature of large computer networks (e.g., new nodes being added to increase a cluster or grid size or to replace failed or obsolete nodes).

Users or tasks can manually transfer files prior to file execution though a multicast or broadcast file transfer protocol. Multicast methods improve network bandwidth utilization over demand based schemes as data is transferred “at once” over the network for all nodes but the final result is the same as for point-to-point methods: when data transfers are complete, synchronization with local workload management facilities must be explicitly performed and additional file transfers must continually be initiated to cope with, for example, the constantly varying nature of large computer networks.

Specialized point-to-point schemes may perform data analysis a priori for each job and package data and task descriptions together into “job descriptors” or “atoms.” Such schemes require extra processing because of, for example, network capacity and I/O rate to perform the prior analysis, and need application code modifications to alter data access calls. Final data transfer size may exceed that of point-to-point methods when a percentage of files packaged per job multiplied by a number of jobs processed per node goes beyond 100%. This scheme, however, requires no manual intervention to synchronize data and task distribution or to handle the varying nature of large computer networks (e.g., new nodes being added to increase cluster or grid size or to replace failed or obsolete nodes). Because data is transferred to processing nodes, there is no performance degradation induced by network latencies as for on-demand transfer schemes.

All four of these methods are based on synchronous data transfers. That is, data for job “A” is transferred while job “A” is executing or is ready to execute.

There is a need in the art to address the problem of replicated data transfers and synchronizing with workload management systems.

### SUMMARY OF THE INVENTION

Advantageously, the present invention implements an asynchronous multicast data transfer system that continues operating through computer failures, allows data replication scalability to very large size networks, persists in transferring data to newly introduced nodes even after the initial data transfer process has terminated and synchronizes data transfer termination with workload management utilities for job dispatch operation.

The present invention also seeks to ensure the correct synchronization of data transfer and workload management functions within a network of nodes used for throughput processing.

Further, the present invention include automatic synchronization of data transfer and workload management functions; data transfers for queued jobs occurring asynchronously to executing jobs (e.g., data is transferred before it is needed while preceding jobs are running); introducing new nodes and/or recovering disconnected and failed nodes; automatically recovering missed data transfers and synchronizing with workload management functions to contribute to the processing cluster; seamless integration of data distribution with any workload distribution method; seamless integration of dedicated clusters and edge grids (e.g., loosely coupled networks of computers, desktops, appliances and nodes); seamless deployment of applications on any type of node concurrently.

The system and method according to the invention improve the speed, scalability, robustness and dynamism of throughput cluster and edge grid processing applications. The asynchronous method used in the present invention transfers data before it is actually needed, while the application is still queued and the computational capabilities of processing nodes are being used to execute prior jobs. The ability to operate persistently through failures and nodes additions and removals enhances robustness and dynamism of operation.

### BRIEF DESCRIPTION OF THE DRAWINGS

FIG. 1 illustrates a system for asynchronous data and internal job distribution wherein a workload distribution mechanism is built-in to the system.

FIG. 2 illustrates a system for asynchronous data and external job distribution wherein a third-party workload distribution mechanism operates in conjunction with the system.

FIG. 3 illustrates a method of asynchronous data and internal job distribution utilizing a built-in workload distribution mechanism.

FIG. 4 illustrates a method of asynchronous data and external job distribution utilizing a third-party workload distribution mechanism.

FIG. 5a illustrates synchronizing between an external workload distribution mechanism and a broadcast/multicast data transfer wherein selective job processing is available.

FIG. 5b illustrates synchronizing between an external workload distribution mechanism and a broadcast/multicast data transfer wherein selective job processing is not available.

FIG. 6 depicts an example of a pseudo-file system structure.

FIG. 7 shows an example of a membership description language syntax.

FIG. 8 shows an example of a job description language syntax.

### DETAILED DESCRIPTION OF AN EXEMPLARY EMBODIMENT

In accordance with one embodiment of the present invention, the system and method according to the present invention improve speed, scalability, robustness and dynamism of throughput cluster and edge grid processing applications. Computing applications, such as genomics, proteomics, seismic and risk management, can benefit from a priori transfer of sets of files or other data to remote computers prior to processing taking place.

The present invention automates operations such as job processing enablement and disablement, node introduction or node recovery that might otherwise require manual intervention. Through automation, optimum processing performance may be attained in addition to a lowering of network bandwidth utilization; automation also reduces the cost of operating labor.

The asynchronous method used in an embodiment of the present invention transfers data before it is actually needed—while the application is still queued—and the computational capabilities of processing nodes are being used to execute prior jobs. The overlap of data transfer for another task, while processing occurs for a first task, is akin to pipelining methods in assembly lines.

The terms “computer” and “node,” as used in the description of the present invention, are to be understood in the broadest sense as they can include any computing device or electronic appliance including a computing device such as, for example, a personal computer, a cellular phone or a PDA, which can be connected to various types of networks.

The term “data transfer,” as used in the description of the present invention, is also to be understood in the broadest sense as it can include full and partial data transfers. That is, a data transfer relates to transfers where an entire data entity (e.g., file) is transferred “at once” as well as situations where selected segments of a data entity are transferred at some point. An example of the latter case is a data entity being transferred in its entirety and, at a later time, selected segments of the data entity are updated.

The term “task,” as used in the description of the present invention, is understood in the broadest sense as it includes the typical definition used in throughput processing (e.g., a group of related jobs) but, in addition, any other grouping of pre-defined processes used for device control or simulation. An example of the latter case is a series of ads transferred to electronic billboards and shown in sequence on monitors in public locations.

The term “jobs,” as used in the description of the present invention, is understood in the broadest sense as it includes any action to be performed. An example would be a job defined to turn on lights by sending a signal to an electronic switch.

The terms “workload management utility” and “workload distribution mechanism,” as used in the description of the present invention, are to be understood in the broadest sense as they can include any form of remote processing mechanism used to distribute processing among a network of nodes.

The term “throughput processing,” as used in the description of the present invention, is understood in the broadest sense as it can include any form of processing environment where several jobs are performed simultaneously by any number of nodes.

The term “pseudo file structure,” as used in the description of the present invention, is understood in the broadest sense as it can include any form of data maintenance in a structured and unstructured way in the processing nodes. For instance, a pseudo file structure may represent a file structure hierarchy, as typical to most operating systems, but it may also represent streams of data such as that used in video broadcasting systems.

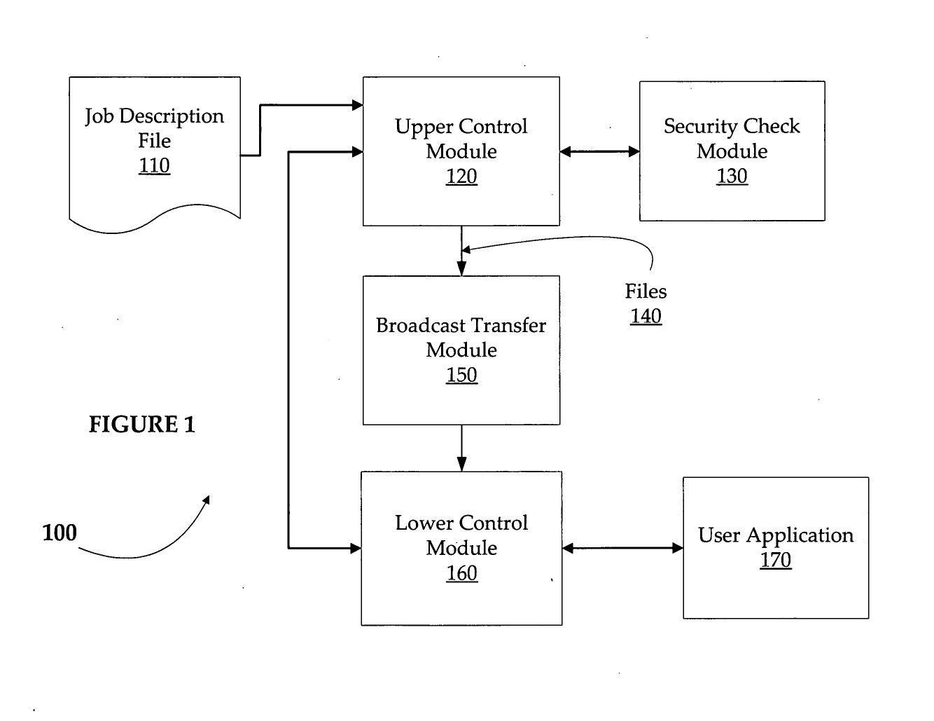

FIG. 1 shows a system 100 for asynchronous distribution of data and job distribution using a built-in workload distribution mechanism. An upper control module 120 and a lower control module 160, together, embody the built-in workload distribution mechanism that allows jobs to be queued at the upper control module 120 level and be distributed to available nodes running the lower control module 160. It should be noted that FIG. 1 shows only whole modules and not subcomponents of those modules. Therefore, the built-in workload distribution mechanism is not shown.

Users submit job description files 110 to the upper control module 120 of the system 100 and user credentials and permissions are checked by an optional security module 130. In one embodiment, the security module 130 may be a part of upper control module 120. The upper control module 120, parsing the job description file 110, then orders transfer of all required files 140 by invoking a broadcast/multicast data transfer module 150. The upper control module 120 then deposits jobs listed into the built-in workload distribution mechanism. Files are then transferred to all processing nodes and upon completion of said transfers, the lower control module 160, which is running on a processing node, automatically synchronizes with a local workload management mechanism and instructs the upper control module 120 to initiate job dispatch.

It should be noted that the upper control module 120 and lower control module 160 of FIG. 1 act as a built-in workload distribution mechanism as well as a synchronizer with external workload distribution mechanisms. Additionally, the synchronization enables the dispatch of queued jobs in a processing node that has a complete set of files.

Jobs are dispatched and a user application 170, also running on a processing node, is launched by an internal (or external) workload distribution mechanism and the internal workload distribution mechanism signaled by the lower control module 160. Jobs continue to be dispatched until the job queue is emptied. When the job queue is empty (i.e., all jobs related to a task have been processed) the upper control module 120 then signals using the data broadcast/multicast data transfer module 150 all remote lower control modules 160 to perform a task completion procedure.

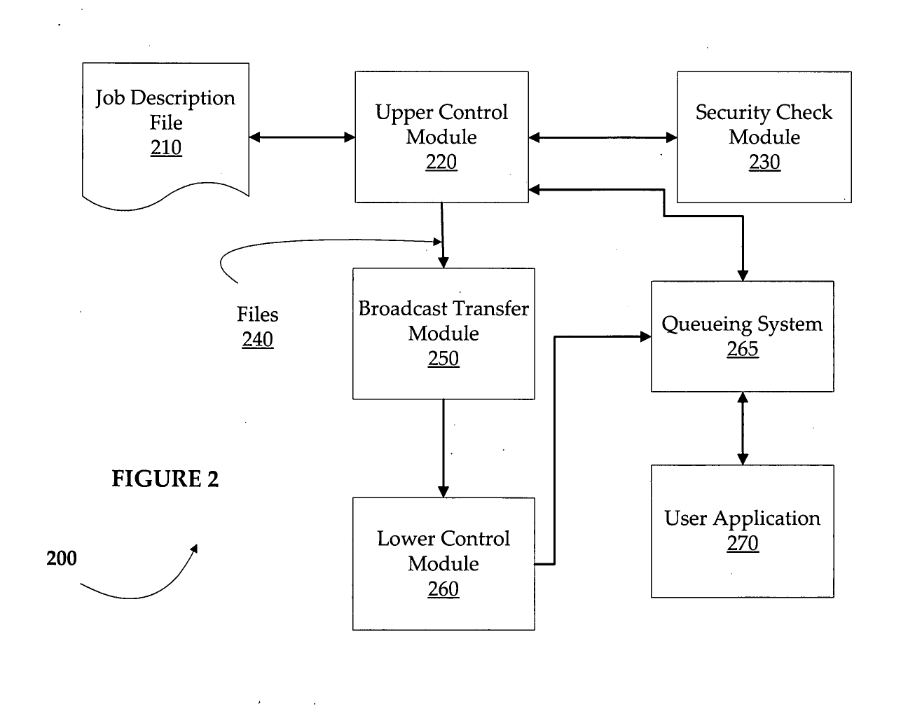

FIG. 2 shows a system 200 for asynchronous data and task distribution interconnection using an external workload distribution mechanism (not shown). Users submit job description files 210 to the upper control module 220 of the system 200 and, optionally, user credentials and permissions are checked by security control module 230. The upper control module 220, parsing the description file, then orders transfer of all required files 240 to remote nodes through a broadcast/multicast data transfer module 250 (similar to broadcast/multicast data transfer module 150 of FIG. 1), and deposits jobs into the external workload distribution mechanism. The external workload distribution mechanism then dispatches jobs (user application) 270 unto nodes.

Files are then transferred to all processing nodes and upon completion of said transfers, the lower control module 260 automatically synchronizes with the local workload management function and enables job dispatch processing for a target queue. Target queues are, generally, pre-defined job queues through which the present invention interfaces with an external workload distribution mechanism. The externally supplied workload distribution mechanism initiates job dispatch and receives job termination signal. Jobs are dispatched and continue to be dispatched until the job queue is emptied. The upper control module 220 polls (or receives a signal from) the workload distribution mechanism to determine that all jobs related to the task have been processed. When the job queue is empty, the upper control module 220 then signals all remote lower control modules 260 to perform the task completion procedure using the data broadcast/multicast data transfer module 250.

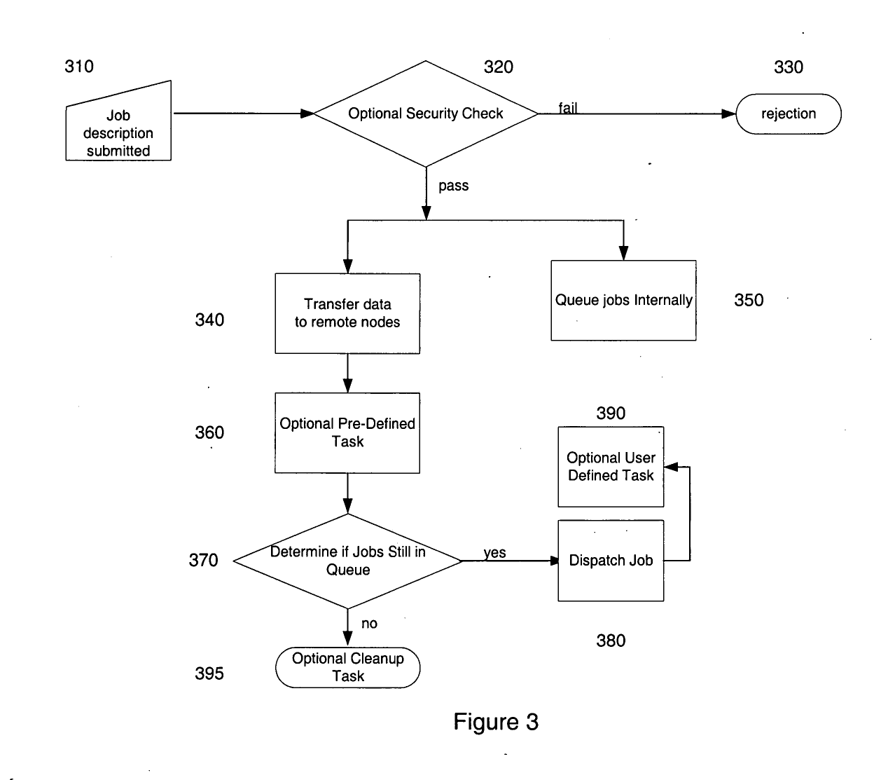

FIG. 3 shows a control flowchart of the system when using the internal workload distribution mechanism as in FIG. 1. A job description file 110 (FIG. 1) is submitted 310 to the system through a program following a task description syntax described below. Parsing and user security checks are optionally conducted 320 by the security check module 130 (FIG. 1) to validate the correctness of a request and file access and execution permissions of the user. Rejection 330 occurs if the job description file 110 is improperly formatted, the user does not have access to the requested files, the files do not exist or the user is not authorized to submit jobs into the job group requested.

Upon success of the validation, the system will initiate data transfers 340 of the requested files to all remote nodes belonging to the target group. File transfers may optionally be limited to those segments of files which have not already been transferred. A checksum or CRC (cyclic redundancy check) is performed on each data segment to validate whether the data segments requires to be transferred. The job description file 110, itself, is then transferred to all remote nodes through the broadcast/multicast data transfer module 150 (FIG. 1).

Data transfers can be subject to throttling and schedule control. That is, administrators may define schedules and capacity limits for transfers in order to limit the impact on network loads.

Meanwhile, jobs are queued 350 in the built-in workload distribution mechanism. The built-in workload distribution mechanism, in one embodiment, implements one job queue per job description file submitted 310. Alternate embodiments may substitute other job queuing designs. Queued jobs 350 remain queued until the built-in workload distribution mechanism dispatches jobs to processing nodes in steps 370 and 380.

Execution at the remote nodes may also be subject to administrator defined parameters that may restrict allocation of computing resources based on present utilization or time of day in order not to impact other applications. Remote nodes, having received and parsed the job description file 110, then may perform an optional pre-defined task 360 as defined in the job description file 110. The pre-defined task 360 is a command or set of commands to be executed prior to job dispatch being enabled on a node. For example, a pre-defined task may be used to clean unused temporary disk space prior to starting processing jobs.

An internal workload distribution mechanism module of each remote node, determines whether there are jobs still queued 370 and, if so, dispatches jobs 380. At the completion of a job, an optional user defined task 390 may be performed as described in the job description file. A user defined task 390 is, for example, a command or set of commands to be executed after a job terminates.

After all jobs have been processed, all remote nodes may execute an optional cleanup task 395.

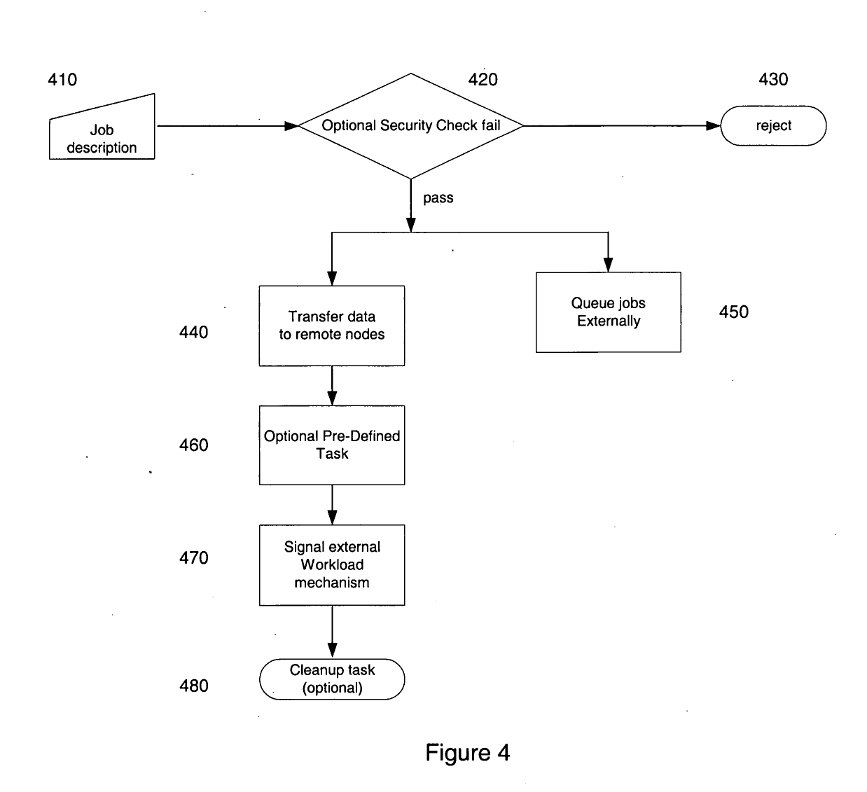

FIG. 4 shows a control flowchart of the system when using an external workload distribution mechanism as in FIG. 2. A job description file 210 (FIG. 2) is submitted 410 to the system through a program following a task description syntax described below. Parsing and user security checks are optionally conducted 420 to validate the correctness of a request and file access and execution permissions of the user. Rejection 430 occurs if the job description file 210 is improperly formatted, the user does not have access to the requested files, the files do not exist or the user is not authorized to submit jobs into the job group requested.

Upon success of the validation, the system will initiate data transfers 440 of the requested files to all remote nodes belonging to the target group. File transfers may be limited to those segments of files which have not already been transferred. A checksum or CRC is optionally performed on each data segment to validate whether it requires to be transferred. The job description file 210, itself, is then transferred to all remote nodes through the broadcast/multicast data transfer module 210.

Data transfers may be subject to throttling and schedule control. That is, administrators may define schedules and capacity limits for transfers in order to limit the impact on network loads.

Meanwhile jobs are queued 450 to the external workload distribution mechanism. Jobs remain queued 450 until signaled 470 wherein a data transfer is initiated.

Execution at the remote nodes is also subject to administrator defined parameters that may restrict allocation of computing resources based on present utilization or time of day in order not to impact other applications.

Remote nodes, having received and parsed the job description file 210, then may perform an optional pre-defined task 460 as defined in the job description file 210. The external workload distribution mechanism is then signaled 470 to start processing jobs as per described in the job description file 210. Signaling may be performed either through the DRMAA API of workload distribution mechanisms or by a task which enables queue processing for the queue where jobs have been deposited depending on the target workload distribution mechanism used. The target workload distribution mechanism may be any internally or externally supplied utility—PBS, N1, LSF and Condor, for example. The utility to be used is defined within the WLM clause 806 of a job description file as further described below.

After all jobs have been processed, all remote nodes may execute a cleanup task 480. A cleanup task 480 is, for example, a command or set of commands to be executed after all jobs have been executed. A cleanup task can be used, for example, to package and transfer all execution results to a user supplied location.

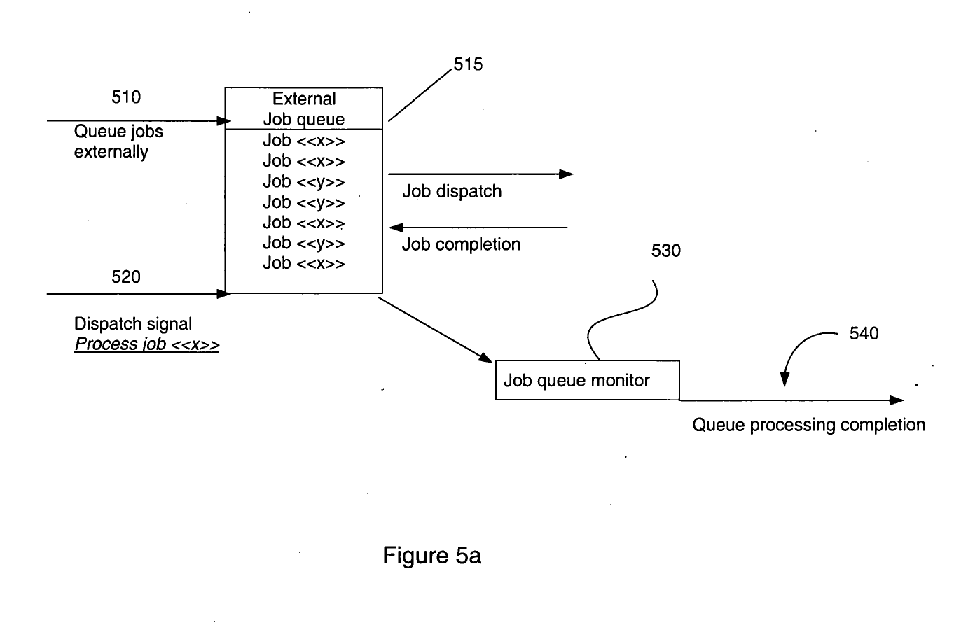

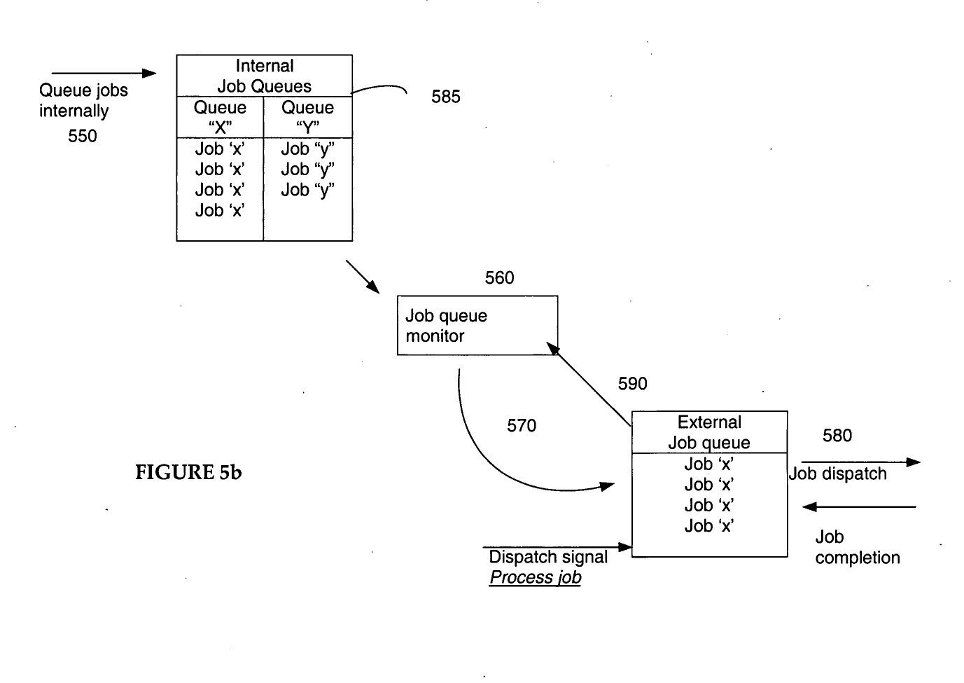

FIG. 5a illustrates the synchronization between the broadcast/multicast data transfer module and an externally supplied workload distribution mechanism when selective job processing is available in the external workload distribution mechanism used. Selective job processing means that jobs from a queue may be selectively chosen for dispatch based on a characteristic, such as job name. As shown, jobs 510 are deposited to a queue 515 in an external workload distribution mechanism. A synchronization signal from the broadcast/multicast data transfer module consists of a selective job processing instruction 520—a DRMAA API function call or a program interacting directly with a workload distribution mechanism, such as a command that enables processing) 520. The present invention's job queue monitor 530 then checks the external job queue 515 (e.g., polls or waits for a signal from the job queue 515) before sending a queue completion signal 540 to all remote nodes.

FIG. 5b illustrates a synchronization between a broadcast/multicast data transfer module and an externally supplied workload distribution mechanism when selective job processing is not available in the external workload distribution mechanism used. Selective job processing means that jobs from a queue may be selectively chosen for dispatch based on a characteristic, such as job name. When this feature is not present, the present invention uses a mechanism, called a job queue monitor 560, where a number of job queues are used in the external workload distribution mechanism to process sets of jobs (as defined in the job description files) while any excess sets of jobs 550 are queued internally. When an external job queue 580 is empty, the job queue monitor 560 transfers (via transmission 570) jobs from an internal job queue 585 to the external workload distribution job queue 580. The job queue monitor 560 polls (or receives a signal 590 from the external workload distribution mechanism) the external job queue 580 to determine its status.

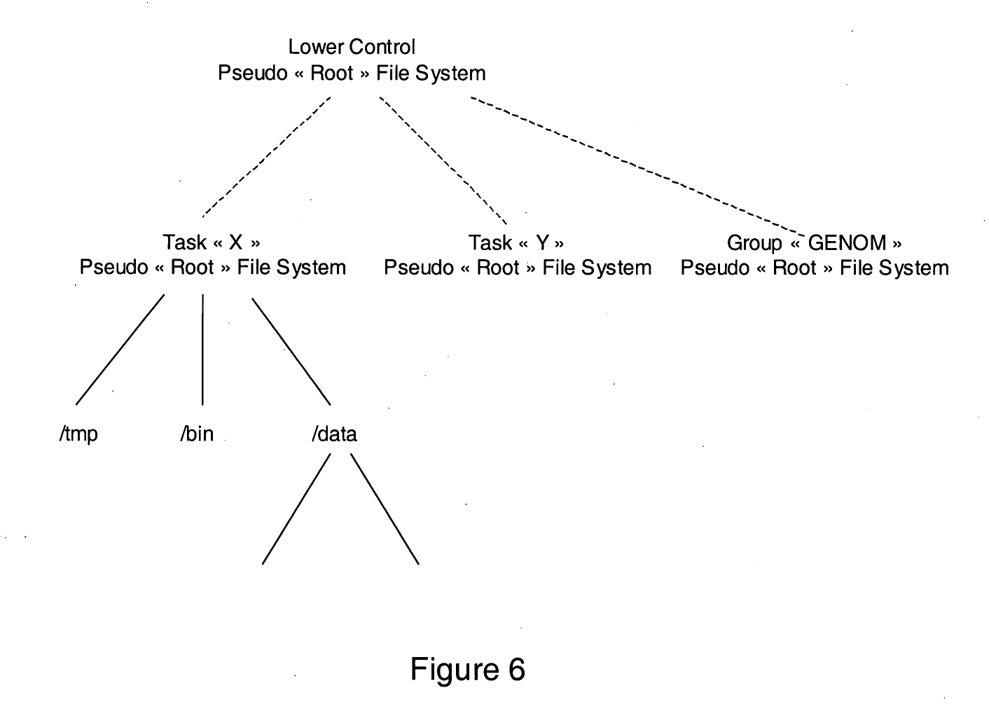

FIG. 6 illustrates an optional pseudo-file structure, wherein each task executes within an encapsulated pseudo-file system structure. Use of the PFS allows for presentation of a single data structure whenever a job is running. File are accessed relative to a <<root>> or a <<home>> pseudo-file system point. By default, <<home>> is set to as task's root. While each task operates within its own file structure, all jobs within a task share the same file structure. The structure remains the same where ever jobs are being dispatched, regardless of the execution environment (e.g., operating system dissimilarities) thereby enabling applications to run on dedicated clusters and edge grids alike. This encapsulated environment allows jobs to operate without modifications to the data/file structure requisites in any environment.

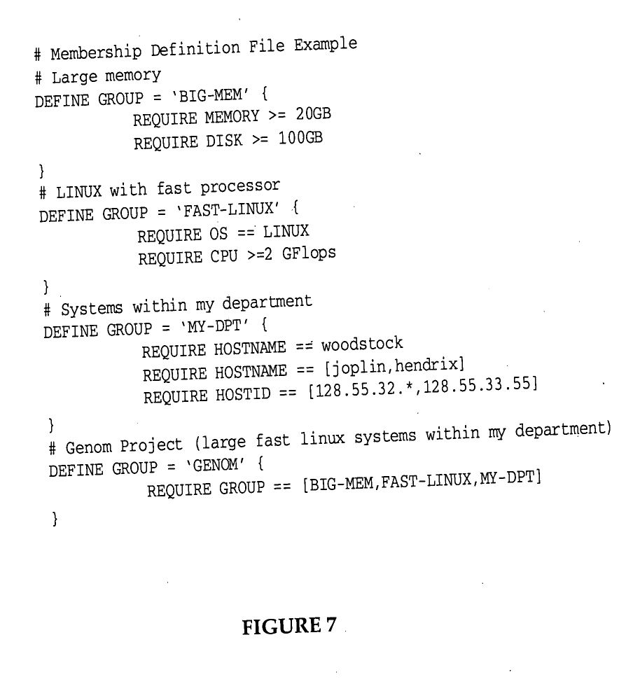

FIG. 7 is an example of an optional group membership description file. A group membership description file allows for a logical association of nodes with common characteristics, be they physical or logical. For instance, groups can be defined by series of physical characteristics (e.g., processor type, operating system type, memory size, disk size, network mask) or logical (e.g., systems belonging to a previously defined group membership).

Group membership is used to determine in which task processing activities a node may participate. Membership thus determines which files a node may elect to receive and from which jobs queues the node uses to receive jobs.

Membership may be defined with specific characteristics or ranges of characteristics. Discrete characteristics are, for instance, “REQUIRE OS==LINUX” and ranges can be either defined by relational operators (e.g., “<”; “>” or “=”) or by a wildcard symbol (such as “*”). For example, the membership characteristic “REQUIRE HOSTID==128.55.32.*” implies that all remote nodes on the 128.55.32 sub-network have a positive match against this characteristic.

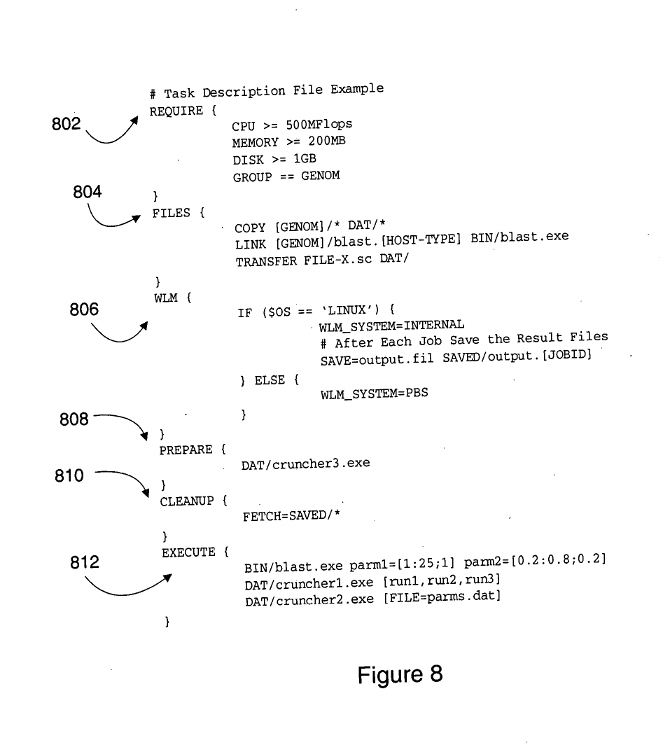

FIG. 8 is an example task description file. A task description file allows connection of a task and data distribution. The exact format and meta language of the file is variable.

Segregation on physical characteristics or logical membership is determined by a REQUIRE clause 802. This clause 802 lists each physical or logical match required for any node to participate in data and job distribution activities of a current task.

A FILES clause 804 identifies which files are required to be available at all participating nodes prior to job dispatch taking place. Files may be linked, copied from other groups or transferred. In exemplary embodiments, actual transfer will occur only if the required file has not been transferred already, however, in order to eliminate redundant data transfers.

Identification of the workload distribution mechanism to use is performed in a WLM clause 806. The WLM clause 806 allows users to select the built-in workload distribution mechanism or any other externally supplied workload distribution mechanisms. Users may define a procedure (e.g., EXECUTE, SAVE, FETCH, etc.) to be performed after the completion of each individual job.

A user defined procedure (e.g., EXECUTE, SAVE, FETCH, etc.) may be defined to execute before initiating job dispatch for a task with a PREPARE clause 808. For example, prior to job dispatch being enabled on a node, a user may free up disk space by removing temporary files in a user defined procedure via a PREPARE clause 808.

A user defined procedure or data safeguard operation (e.g., EXECUTE, SAVE, FETCH, etc.) may be defined to execute at completion of a task (e.g., all related jobs having been processed) within a CLEANUP clause 810. For example, all jobs have been executed, a user may package and transfer execution results through a user defined procedure via a CLEANUP clause 810.

An EXECUTE clause 812 lists all jobs required to perform the task. The EXECUTE clause 812 consists of one of more statements, each of which represent one of more jobs to be processed. Multiple jobs may be defined by a single statement where multiple parameters are declared. For instance the ‘cruncher.exe [run1,run2,run3]’ statement identifies three jobs, namely ‘cruncher.exe run1’, ‘cruncher.exe run2’ and ‘cruncher.exe run3’. Lists of parameters may be defined in a file such as in the following statement ‘cruncher.exe [FILE=parm.list]’. Multiple jobs may also be defined through implicit iterative statements such as ‘cruncher.exe [1:25;1]’, where 25 jobs (‘cruncher.exe 1’ through ‘cruncher.exe 25’) will be queued for execution, the syntax being [starting-index:ending-index;index-increment]’.

Task description language consists of several built-in functions, such as SAVE (e.g., remove all temporary files, except the ones listed to be saved) and FETCH (e.g., send back specific files to a predetermined location), as well as any other function deemed necessary. Moreover, conditional and iterative language constructs (e.g., IF-THEN-ELSE, FOR-LOOP, etc.) are to be included. Comments may be inserted by preceding text with a ‘#’ (pound) sign.

A combination of persistent connectionless requests and distributed selection procedure allows for scalability and fault-tolerance since there is no need for global state knowledge to be maintained by a centralized entity or replicated entities. Furthermore, the connectionless requests and distributed selection procedure allows for a light-weight protocol that can be implemented efficiently even on appliance type devices.

The use of multicast or broadcast minimizes network utilization, allowing higher aggregate file transfer rates and enabling the use of lesser expensive networking equipment, which, in turn, allows the use of lesser expensive nodes. The separation of multicast file transfer and recovery file transfer phases allows the deployment of a distributed file recovery mechanism that further enhances scalability and fault-tolerance properties.

Finally, the file transfer recovery mechanism can be used to implement an asynchronous file replication apparatus, where newly introduced nodes or rebooted nodes can perform file transfers which occurred while they are non-operational and after the completion of the multicast file transfer phase.

Activity logs may, optionally, be maintained for data transfers, job description processing and, when using the internal workload distribution mechanism, job dispatch.

In one embodiment, the present invention is applied to file transfer and file replication and synchronization with workload distribution function. One skilled in the art will, however, recognize that the present invention can be applied to the transfer, replication and/or streaming of any type of data applied to any type of processing node and any type of workload distribution mechanism.

Detailed descriptions of exemplary embodiments are provided herein. It is to be understood, however, that the present invention may be embodied in various forms. Therefore, specific details disclosed herein are not to be interpreted as limiting, but rather as a basis for claims and as a representative basis for teaching one skilled in the art to employ the present invention in virtually any appropriately detailed system, structure, method, process, or manner.

1. A method comprising:
transferring data with a workload distribution mechanism between at least two computing devices using a transfer protocol; and
synchronizing workload distribution mechanisms with a synchronizer wherein job dispatch functions of at least two computing devices are enabled or disabled.

2. The method of claim 1 wherein the transfer protocol comprises a multicast protocol.

3. The method of claim 1 wherein the transfer protocol comprises a broadcast protocol.

4. The method of claim 1 wherein transferring data is used for transferring already transferred data from one of the at least two computing devices to a newly connected computing device.

5. The method of claim 1 wherein transferring data is used for completing interrupted data transfers.

6. The method of claim 1 wherein the transferred data comprises segments of a file.

7. The method of claim 1, further comprising recording received data and received jobs in a log at each computing device of said at least two computing devices.

8. The method of claim 1, further comprising performing a security check on a job description file to validate a request.

9. The method of claim 8 wherein validation comprises file access permissions.

10. The method of claim 8 wherein validation comprises execution permissions.

11. A computing device for transferring data and synchronizing workload distributions comprising:
a data transfer module configured for transferring data to a second computing device using a transfer protocol; and
a synchronization module configured for synchronizing work load distribution mechanisms and enabling or disabling a job dispatch function.

12. The computing device of claim 11 wherein the protocol comprises a broadcast protocol.

13. The computing device of claim 11 wherein the protocol comprises a multicast protocol.

14. The computing device of claim 11 further comprising a security module for performing a security check on a job description file to validate a request.

15. The computing device of claim 14 wherein the security module validates file access permissions.

16. The computing of claim 14 wherein the security module validates execution permissions.

17. A computer readable medium having embodied thereon a program, the program being executable by a machine to perform a method of transferring data and synchronizing workload distributions, the method comprising:
transferring data based on a data transfer phase between at least two computing devices using a transfer protocol; and
synchronizing workload distribution mechanisms based on a synchronization phase wherein job dispatch functions of at least two computing devices are enabled or disabled.

18. The computer readable medium of claim 17 wherein the computer readable medium is executed by an electronic appliance.

19. The computer readable medium of claim 18 wherein the electronic appliance is a personal computer.

20. The computer readable medium of claim 18 wherein the electronic appliance is a cellular phone.

21. The computer readable medium of claim 18 wherein the electronic appliance is a PDA.
